(19) United States
(12) Patent Application Publication
(10) Pub. No.: US 2007/0050756 A1
(43) Pub. Date: Mar. 1, 2007

(54) Component architecture

(75) Inventor: Gabor Paller, Budapest (HU)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/211,302

(22) Filed: Aug. 24, 2005

(51) Int. Cl. G06F 9/44

(52) U.S. Cl. 717/117

(57) ABSTRACT

A self-organising software for controlling a device, which software contains at least two components. Each component includes at least one interface for connecting with other components, wherein each of the components itself contains information defining component rules. The rules contained by the components define how components can be connected with each other components so that no external rule databases are necessary.

### FIELD OF THE INVENTION

The invention generally relates to component architectures. More particularly, but not exclusively, the invention relates to self-managing component architectures for mobile devices.

### BACKGROUND OF THE INVENTION

Component architectures are widely used in software industry. Reconfigurable architectures have recently drawn attention due to their relevance in mobile middleware and self-managing systems.

A common property of the mobile application platforms is the dynamism of the environment. Services may become available or unavailable based on geographical location or proximity to other terminals. Based on the available services and their required properties (bandwidth, device properties, such as screen size) applications may have to adapt themselves and the middleware that serves their communication needs. A widely used approach is to use a component model and to dynamically change the connection (“wiring”) of the components by adding and removing new components to or from an application or by connecting application components to different middleware components.

Dynamic wiring is necessary for so-called reflective middleware. Reflective middleware are based on the principle of reflection which enables a program to access information about its own code base and the code base of the middleware. The program can then analyse behavioural patterns and adapt its behaviour. The change required to accomplish this may be significant and crosscutting for the application logic that cannot be realized using the well-known hierarchical decomposition.

Further background art is disclosed in the following references incorporated by reference herein: Jeremy S. Bradbury et al.: A Survey of Self-Management in Dynamic Software Architecture Specifications, Proc. of the International Workshop on Self-Managed Systems (WOSS'04), Newport Beach, Calif., USA, October/November 2004, Marija Mikic-Rakic and Nenad Medvidovic: Support for Disconnected Operation via Architectural Self-Reconfiguration. All those architectures seem to use some external definition language to describe the component system. The prior art concentrates mainly on the reasoning engine and rule description.

The prior art known uses a centralized rule engine, but unfortunately it is hard to create an exhaustive rule base for the rule engine and in case of malfunction of the rule engine, the self-adaptation will fail.

### SUMMARY OF THE INVENTION

It is an object of the invention to avoid or at least mitigate the problems of the prior art and/or to provide a new technical alternative.

According to a first aspect of the invention, there is provided a device including self-organising software that includes at least two components each including at least one interface for connecting with other components, wherein each of the components contains information defining component rules according to which that component can be connected with other components.

Advantageously, the self-organising software may work independent of external rule databases.

The components may further contain information defining interface rules according to which interfaces of components can be connected with interfaces of other components. The device may be configured to let the interface rules override the component rules.

The component rules and/or the interface rules may contain optional rules which require certain condition to be met.

Advantageously, the interface rules, the overriding of component rules and providing conditional rules may each provide further flexibility. Advantageously, this allows the presence of some interfaces to have special significance which overrides normal component rules. For example, it may be necessary to state that only certain component interfaces can be connected. In this case, the component rule can disable connection but the interface rule enable it. The result is that the interfaces for which interface rules were specified can be connected but other interfaces cannot.

Each component and or each interface may be associated with a given weight or priority and the device may be configured to connect interfaces in dependence of these weights or priorities. Advantageously the priorities or weights may enhance the reconnection process to favour desired combinations or connections of components.

Each or at least some of the components may be associated with a predetermined, optionally individual lifetime after which the components with a lifetime are deleted.

The self-organising software may be organised according to a hierarchical component model.

The component rules and/or interface rules may be stored in the components as metainformation. The meta-information may include any of the following options: mandatory properties defining a required property and its value of another component that can be connected with the component in question; conditional properties defining a property of another component that must have a given value if existent for the component to be connected with the component in question; and forbidden properties defining values which a property of another component must not have to be connected. The values of the properties may be given as single value, as ranges or as plural values and/or ranges.

The components may include primitive components capable of exposing their meta-information. The components may include one or more composite components capable containing other components by arranging connections of other components and capable of exposing meta-information dependant on the other components contained by the composite component.

Advantageously, a composite component, or a container, may create a composite unit capable of bringing a plurality of components to act together in a unified manner and to appear as one, enhance component. Advantageously, a composite component may contain either or both primitive components and composite components.

The composite component may be associated with a domain storage for containing components contained by the composite component. The domain storage may store the components that are not connected in the domain and have not yet expired. The container may be configured to maintain the domain storage and to move components into the domain storage and out of the domain storage depending on whether components are to join or leave the composite component.

The components may have super-properties that determine a container the component can be joined into.

The device may be configured to reconnect all components contained by a composite component when a component is inserted into the domain storage. The device may be configured to establish a reconnection identification capable of distinguishing any new reconnection from recent reconnections so that each container within the domain storage can recognise whether it has been checked during the new reconnection.

Advantageously, the device may enable determining the necessary component wirings based on the changes in the environment of the component architecture.

Advantageously, the device may be seen to mimic behaviour of biological cells. The component may contain interfaces or ports divided to optional and mandatory interfaces, each of a specific type. A component may become functional when all the mandatory interfaces are connected with other components. A component may connect to another component only if the components to be connected together have interfaces of a common type.

The device may be configured to store components that are not active (all their mandatory interfaces are not occupied, for instance). The device may further be configured, when a new component is added to the system, to check the interfaces of available components to search for matching interfaces.

Advantageously, the system may provide a new type of a self-managing component architecture. Unlike prior known self-managing component architectures, the knowledge about the adaptation (rules or constraints) may be configured within the interfaces of the components. In other words, no additional centralised database of description files is needed to govern the adaptation.

The components may be provided by different vendors. Some components may be, for instance, provided based on open source software (OSS) whilst some others may be commercial and dependant on patent licenses. This would further enable providing the unprotected parts of the application using OSS.

According to a second aspect of the invention there is provided a self-organising software for controlling a device, including at least two components each including at least one of interfaces for connecting with other components, wherein each of the components contains information defining component rules according to which that component can be connected with other components.

According to a third aspect of the invention there is provided a method of self-organising software, including: identifying at least two components each including at least one interface for connecting with other components, obtaining from the components rules specific to each of the components, and determining based on the rules how each of the components can be connected with other components.

The software may be provided as a computer product or products carried and/or stored on a data medium or embedded in a data signal. The software may also be hosted by one or more devices (distributed model).

Dependent claims and the aforementioned embodiments relate to different embodiments of the invention. The subject matter contained by the embodiments and relating to a particular aspect of the invention may be applied to other aspects of the invention mutatis mutandis.

### BRIEF DESCRIPTION OF THE DRAWINGS

Embodiments of the invention will now be described by way of example with reference to the accompanying drawings in which:

FIG. 1 a shows a block diagram of an equipment according to an embodiment of the invention;

FIG. 1b shows a block diagram of details of the elements of the software environment used by the equipment of FIG. 1a;

FIG. 2 shows a hierarchical component architecture model according to an embodiment of the invention;

FIG. 3 shows an exemplary connection of component interfaces;

FIG. 4 illustrates using priorities to modify component networks;

FIG. 5 illustrates overriding component properties with interface properties;

FIG. 6 illustrates bidirectional component interfaces;

FIG. 7 illustrates creating demo groups;

FIG. 8 illustrates deleting individual demo components;

FIG. 9 illustrates a component connection rearrangement on changing between grid and tabbed view in a demo application;

FIG. 10 illustrates a component connection rearrangement on activating a performance monitor in the demo application;

FIG. 11 illustrates moving component groups in the hierarchy;

FIG. 12 shows a causality chart with vertical timeline illustrating the operation of the framework and of the components in rearranging the connections of the demo application.

### DETAILED DESCRIPTION

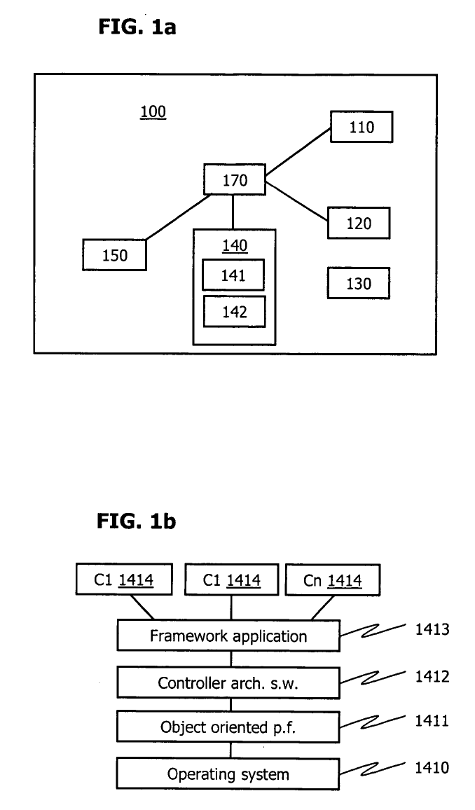

In the following, two examples will be described with reference to drawings. Both of these exemplify component architectures with dynamic wiring. Either of these two examples can be performed with the equipment 100 shown in FIG. 1a.

FIG. 1a shows an equipment 100, such as a Mobile Communication Device (MCD), for running dynamically wired applications, that is, software that can automatically adapt itself such that the required features are loaded and executed and new features or components may be introduced during the operation. The MCD 100 includes a communication block 110, a user interface 120 for data exchange (input and output) with a user, a battery 130 for powering the equipment 100, a persistent or non-volatile memory 140 for storing computer program code 141 and long-term data 142, a work memory 150 for buffering data for fast processing, and a processor 160 for executing the stored computer program code and for thereby generally controlling the operation of the other parts of the MCD 100. The communication block 110 is typically a radio block such as a cellular radio network compatible unit capable of receiving and/or transmitting computer user data and possibly also program code over a cellular network.

FIG. 1b shows a block diagram of details of the elements of the software environment used by the equipment of FIG. 1a. These elements typically consist of computer program code 141 stored in the persistent memory 140 and comprise the following main elements running on top of each other, counting from the bottom: an operating system 1410, an object oriented platform 1411 such as Java Runtime Environment (JRE), general component framework software 1412 such as Julia 2.1 implementation of the Fractal component framework, dynamic component wiring framework application needed to connect the components automatically 1413 and a plurality of software components 1414 capable of running, as separate component instances on the controller architecture software under control of the framework application 1413. The object oriented platform 1411 can be a software system that provides object abstraction such as object creation, invocation of object methods.

The plural software components contained by the containers are typically so-called primitive components, that is, components that can expose their constraints for use in dynamic composition.

The containers can rearrange other components contained in the composite component, including further composite components, by using method calls to the underlying framework 1413 or by otherwise instructing the framework to do so. The collection of components a composite component manages is referred to as a domain of the composite component. Composite components are also able to expose their constraints via the framework 1413 (that is capable of querying these from the components) in the same way as primitive components do. The composite components are further able to participate in transferring components into and out of the composite component.

It is well-known from object oriented programs that the components can be stored as computer executable code in a memory for running and that the components when executed occupy their own footprint of the working memory 150 and service as program or component instances. In this document, the component instances are generally referred to as components in sake of brevity, unless their physical storage in the persistent memory is being discussed. A goal of different embodiments herein is to free the work memory 150 from unnecessary memory consuming component instances. Therefore, the destruction of components and other terms are intended to describe deletion a representation of the component in the working memory 150 whilst the component itself is typically maintained in the persistent memory 140 to avoid continually obtaining the same code each time a component is needed.

### FIRST EXAMPLE

There is an enterprise inventory application running in the MCD 100 for network server based and stand-alone use depending on the situation. The inventory application works differently depending whether the application is connected to an enterprise network by a high-speed link, by a high-speed network to the public Internet, by a low-speed connection to the enterprise network or whether the application is not connected to the enterprise network at all. The application contains several User Interface ((UI) components connected to data access components, including a UI container. The UI components include mandatory components that are always present and supplementary UI components that are present only when the application is used in certain context or contexts. The data access components depend on the communication channel used in a following manner:
When the application is able to connect to the enterprise network over high-speed link, the UI container adds some components such as images of the product or detailed product documentation in the inventory or current inventory level. A data access component directly connects to a server as the latency of the server is low and synchronous communication is possible, owing to due to the high-speed link. The data access component makes use of an enterprise authentication component. The data access component uses thereby a communication protocol suitable for enterprise environment, such as Common Object Request Broker Architecture (CORBA). The application also replicates inventory information to an on-device database automatically, at scheduled intervals for disconnected usage.
When the application is able to connect only to the public Internet but it is not authenticated to use the enterprise services, the application is given access to limited inventory services offered publicly, such as over Web Services. This limited inventory does not allow querying current inventory level; less detailed product documentation is available. Hence, the UI container adapts the application to the limited data available so that the UI components displaying data not available are removed and the data access component is swapped with a web services-enabled data access component. Replication components are also removed.
When only low-bandwidth communication is available, the UI container reverts the application to use a locally replicated database on the host device of the application. As the device storage space is scarce in portable devices, even less details are available. Conversely, the UI contains less UI components and the data access component connects to the locally replicated database. A low-speed replication component is installed. At the same time, a different communication protocol may be opted for, because the low-speed bearer benefits from suitably adapted replication strategy. Also, the replication is not automatic as it is a lengthy process that potentially consumes the complete communication bandwidth of the device. The UI container updates the UI with components directed to manually launch the replication and to present status indication while the replication progresses.
When the absence of connection to the network, the UI container removes all replication features.

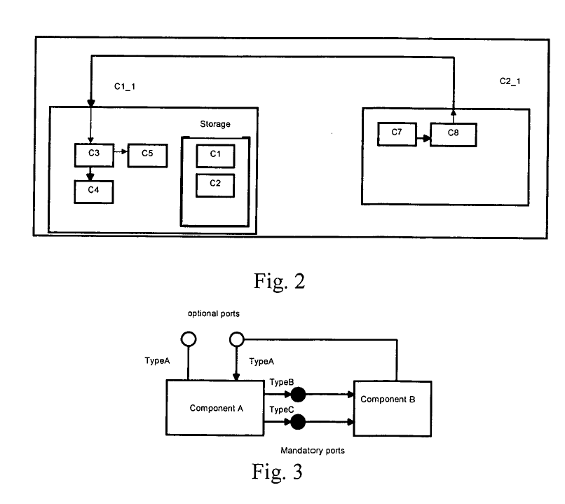

FIG. 2 shows a hierarchical component model according to an embodiment of the invention. FIG. 2 shows a number of components, including components C1_1 and C2_1 that are respectively first and second composite components (that is, containers of other components), and components C1 to C8 contained by the containers C1_1 and C2_1. The first container contains two unconnected components C1 and C2, whilst three other components are connected (also known as “wired together”). Components communicate through interfaces (aka ports). Interfaces can be optional or mandatory (see FIG. 3). The interfaces are typed, that is, only interfaces of a common type are connectable. A component is functional only if all of its mandatory interfaces are connected to other components. In FIG. 3, both component A and B have their mandatory interfaces connected and one of their optional interfaces is also connected. Component A has one unconnected optional interface but as the mandatory interfaces are connected, both components are functional.

The component model can be seen, with hindsight to the invention, to resemble the processes of a living biological cell. A self-managing logic is distributed into the components that are created according to a “genome”. The “genome” corresponds to a list of components that should be created. These components have typed interfaces and if all the required interfaces are satisfied, that is, if there are other components with the correct type and amount of unconnected interface, the component is automatically connected. Unconnected components circulate freely in the system and are stored until their lifetime expires.

The components may also destroy themselves. For example if a certain component does not receive a request for a predetermined time, it may destroy itself and thus potentially destroying an entire component network. This allows unused functionalities to be cleaned up so that memory can be saved. When a request arrives, the component chain can be reconstructed from the genome.

Components have full control over the component network: they can tear up existing connection and build themselves into existing component networks, they can launch processing of “genome” parts or can release other components into the system or they can even change the genome itself. The result is that the self-adaptation logic is distributed into the individual components and can be extended easily by merely injecting other components into the system or extending the “genome”.

In order to control component connections, properties may be assigned to components and component interfaces. The properties are able to express rules like e.g. “this component can only be connected to components where property a=5” or “this component must not be connected to a component where property a=5” or “this component can be connected to a component which has property “a” set to any value”. The component framework may use simple or complex matching rules among components.

Properties assigned to component interfaces can overwrite properties assigned to components. For example, a component property may define that this component must not be connected to a component having property “a” with value 5 (a=5). The property assigned to the interface may overwrite this rule and may state that this interface requires the respective interface of the other component to have property a=5. In this case, the property rules assigned to the interface prevail over the properties assigned to the component. FIG. 5 demonstrates this effect.

Besides the property set used to determine if two components can be connected, there is another property set that is used to determine whether a component can be placed into the domain of a parent component. This property set is called super-properties. A component can be tentatively placed into the domain of a parent component and then its super-properties be matched against the normal properties of the parent component. If there is a match the component can be placed into this domain and can be connected with components in this domain. If there is no match, the component cannot be placed into this domain and will be put to the storage to expire or to be exported out of this domain.

Depending on the environment where this architecture is used, the components may use local method invocations or remote protocol to communicate with each other.

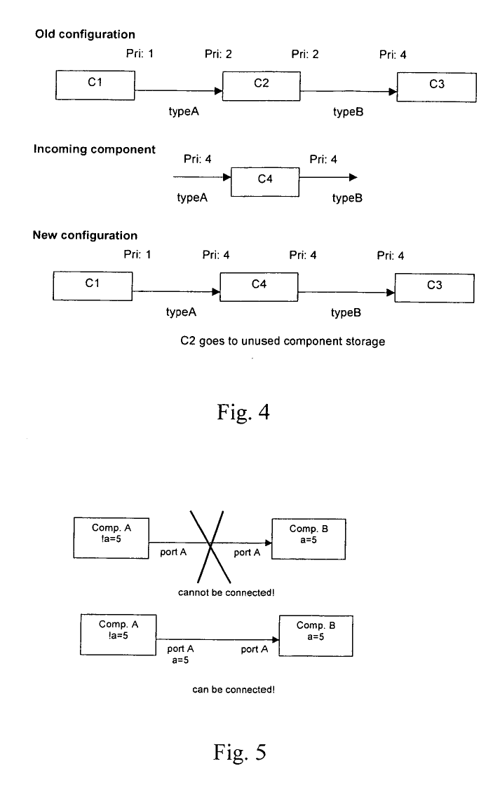

Interfaces also have priorities assigned to them indicative of the order in which the interfaces should be connected. This makes possible for one component to insert itself into the network of already connected components. If the priorities of the existing connections are lower than the incoming component's interface priorities and the incoming component can be connected into the existing component network, the highest priority of interface connection wins. Hence, an incoming component can replace old component(s) and an incoming component can build itself among old components (see FIG. 4.)

Components with unconnected mandatory interfaces are said to be unresolved and are stored in a storage area assigned to the owning component (see FIG. 2) Components have (possibly unlimited) lifetime that they can spend in the storage. If the component exceeds its storage lifetime, it is destroyed.

The application program introduces its new components into a domain. The container's domain is (re)connected using the framework, that is, the framework acts on behalf of the composite component. The framework connects the components and puts the unconnected components into the storage belonging to the composite component so that each composite component has its own storage.

Components have a mechanism to introduce a new component into their domain. When new components are introduced into a composite component's domain, resolution process starts. During this process, interface types, priorities and unused components in the storage are used to create a new component network (which may be the same as the old one). At the end of the resolution process the new component network is set up and unused components are put into the storage.

Components are exported and imported among domains based on export and import filters. The export filter operates on components in the unconnected component storage. The components selected by the export filter are removed from this domain's storage and are placed into the parent component's storage then the parent component's domain is resolved. Similarly, import list exist to select components in the parent component's unconnected component storage and import them into the child domain, prompting resolution. Export and import filters govern the flow of unconnected components between the parent and children domains.

### SECOND EXAMPLE

A model implementation called Dynacomp is next described. The Dynacomp is built on top of a Fractal framework as that described by E. Bruneton and T. Coupaye and J. Stefani, Recursive and dynamic software composition with sharing, In Proceedings of the 7th ECOOP International Workshop on Component-Oriented Programming (WCOP'02), Malaga (Spain), June 2002. The Dynacomp framework uses two types of components that extend Fractal's composite and primitive component types. Additionally to Fractal's features the following functionalities are provided by the Dynacomp component types.

The terms used in describing the Dynacomp model are next explained following which a Java based case study is described.

The constraints are provided by individual component instances. Therefore, component instances directly control the reconnection procedure by means of these constraints. The components contain further meta-information in addition to the quite limited meta-information already available in the Fractal framework. The following meta-information are used in this example.

Interface name: Each interface is named and only interfaces with the same name can be connected. The interface name convention comes directly from the Fractal network.

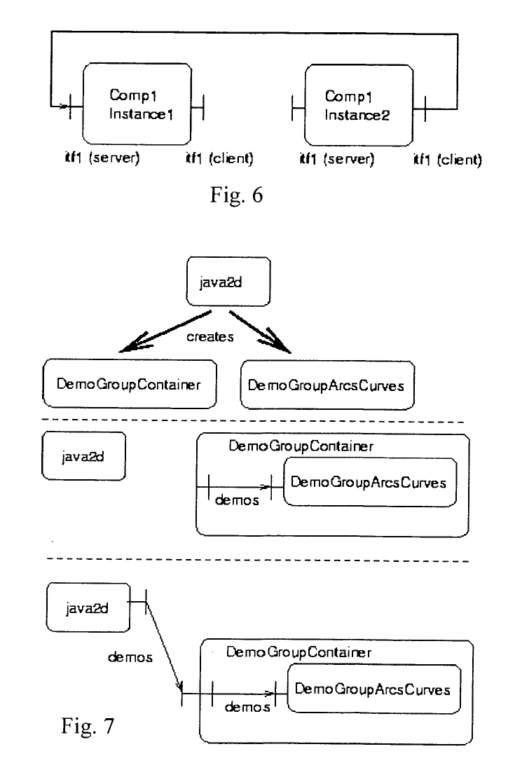

Interface direction: Beside Fractal network client (outgoing) and server (incoming) interfaces, the dynamic composition framework introduces the bidirectional interface type, see FIG. 6. A component exposing bidirectional interface has one client and one server interface with logically the same name. Due to a Fractal restriction, the real names cannot be the same. One bidirectional interface can be connected only to another bidirectional interface. The bidirectional interface is connected in random direction, for example, the client interface of the first component is connected to the server interface of the second component. The server interface on the first component and the client interface of the second component is left unconnected. Bidirectional interfaces are able to express the statement that certain component instances of same type have to be connected with each other. Without the notion of bidirectional interface, this statement would create loop in the connection graph hence the component network could not be started.

Interface multiplicity: Fractal makes difference between the singleton and collection cardinality. Automatic composition needs more precise description of allowed interface connections. The Dynacomp adopts the cardinality description of Service Binder explained by H. Cervantes and R. S. Hall, Automating Service Dependency Management in a Service-Oriented Component Model, ICSE CBSE6 Workshop, 2003. The cardinality of the interface (both client and server) can be one, one or more, zero or one, zero or more connections. Cardinality can be specified for both client and server interfaces.

Interface priority: Priority is assigned to all component interfaces. Priority determines which component interface to select for connection in case there are multiple component interfaces satisfying the search criteria. The priorities of the interfaces to be connected are added and the interface pair with the largest sum is selected for connection.

Component and interface properties: Resembling with Service Binder, it is possible to narrow component instance candidates by means of matching component instance or interface properties. Service Binder, according to the Open Source Service Gateway Initiative (OSGi) service property convention, allows properties to be assigned to individual interfaces of the component. The Dynacomp assigns properties primarily to components which can be overridden by properties assigned to interfaces. The properties are matched according to a very simple pattern language. This language is able to describe that the other component must have a certain property with a certain value (mandatory property), that the other component may have a certain property and in this case the value must be the same as the value of the component to match (optional property) and that the other component is not allowed to have a certain property with certain value (forbidden property). The pattern or constraint language is a footprint-complexity trade-off. More complex constraint language is favorable but costs more memory and reconnection time.

Super-properties: Components may have super-properties that determine the container component this container can be placed into. The component can be imported into the container only if its super-properties match the container's properties. The matching rules are same as those of component and interface properties.

Export and import lists: Containers can have export and import lists controlling which components can leave the domain of this container and which components can be moved into this container. CHAM, or P. Inverardi, A. L. Wolf, Formal Specification and Analysis of Software Architectures Using the Chemical Abstract Machine Model, IEEE Transactions on Software Engineering, volume 21, no. 4, 1995, has a resembling mechanism but CHAM applies it to data items instead of components. The export and import list contain interface names. If an unconnected component has an interface with the name on the export or import list, it may be exported to higher (enclosing) domain or component from the higher domain may be imported into this domain. The import happens only if the component's super-properties match the properties of the domain.

Timeout: Unconnected components “expire” after a timeout and are removed from the storage by the framework.

Creation time: The framework places a timestamp on components when they are created. This timestamp can be used to implement conflict resolution logic based on component age, for example, if a component detects that it is in conflict with some other component in the domain, the surviving component may be the younger one.

Creation list: Each component is assigned a creation list. This is a list of component names. The list may also contain labels. The creation list can be considered a scenario about how the domain should be rearranged by inserting a set of components into the domain. When certain event occurs, the event handler can look up a certain label in the creation list and create all the components whose name is in the list starting from this label up to the next label. This activity can be done by the component itself (using its own creation list) or by components specializing on processing other components' creation list.

Interface name, direction, multiplicity and priority are common for each component of the same type, other metainformation can be set per component instance.

First, a component is inserted into the container's domain and the framework arranges the domain. This happens so that the Framework starts a component instance. Components are stopped, connected according to their constraints, the connected components are started in dependency order and the unconnected components are placed into the storage of the domain. Components in the storage may be exported into higher domain, imported into the domain of a container in this domain or deleted if the unconnected component's timeout has expired. The exact algorithm is described below. For the purpose of this description the set of components already existing in the system is denoted as C. The component to insert is denoted as cᵢ and the component whose domain it is inserted into as c_{p.} The set of components in the domain of c are denoted as child(c) and the container in which c resides is denoted as parent(c). parent(c) is theoretically a set but the Dynacomp does not support the Fractal feature that one component can be part of multiple domains. In the Dynacomp model|parent(c)≡1 for any cεC.
The reconnection procedure is assigned an identification number. This reconnection ID must be unique (successive reconnection passes must have different IDs) so that each container can recognize whether it was visited by this reconnection pass.
cᵢ is added as a subcomponent of cp at Fractal level.
Every c|cεchild(cₚ) are stopped and components are disconnected.
The components in the domain of cₚ (including those in the storage) are reconnected. When connecting interfaces, the framework considers interface names, properties, direction and multiplicity. Note that in order to minimize reconnection time, the algorithm is greedy, it connects interfaces with the highest priority and does not consider whether more components could be eventually connected with non-greedy strategy. After the connection pass components are said to be resolved when each mandatory interface of the component is connected. Unresolved components are put into the storage.

The storage is propagated downward, toward the composite subcomponents of cₚ. Each composite subcomponent is examined whether it is able to import any component in the storage (any component in the storage has an interface whose name is in the import list of the composite subcomponent) and whether the super-properties of the components in the storage match those of the composite subcomponent. If it is found that any component can be imported into a composite subcomponent, that subcomponent is reconnected after the import. As a side-effect, the composite subcomponent may become resolved which requires another reconnection pass in the domain of cₚ.
The components in the storage are checked for timeout. When a component enters the storage, its base for timeout is set. This base time is used to calculate timeout. If the component's timeout expires, the framework removes the component.
If any composite subcomponent became resolved, the components are disconnected again and another iteration occurs. Note that this may be an endless loop. This is considered to be the programmer's fault who is expected to create component networks that can be resolved by this algorithm.
All the components in the domain of cₚ are started in dependency order. Simple As Soon As Possible (ASAP) schedule described in Michael C. McFarland, Tutorial on High-Level Synthesis, 25th ACM/IEEE Design Automation Conference, 1988 IEEE is calculated and components with lower ASAP time are started first. During this process composite subcomponents are started recursively—when the composite subcomponent is started, every subcomponent in its domain is also started.
The component network may change when the components are started. For example a startFc( ) method of some component may delete the component itself or some other component, hence connected components may become unresolved. If any component becomes unresolved during the start of the component network, the whole reconnection procedure restarts.
Components still in the storage are propagated up, to parent(cₚ). This process is controlled by the export list of cₚ, the super-properties of parent(cₚ) and the properties of the component to export. If the export is successful, the exported component is removed from the domain of cₚ and is placed the domain of parent(cₚ) which is then reconnected. By using the reconnection ID the framework guarantees that the exported component will not be reimported into the domain of cₚ during this reconnection pass even if this reimport were possible. This prevents “ping-ponging” with a component between a parent and a child container.

It should be understood that the optimization criteria of the algorithm only approximates the optimal global component arrangement. Greedy connection algorithm connects as many components as it can to high-priority interfaces. If a component can be connected in a domain, the framework will never try to connect this component in another domain even though the component could be exported or imported into that domain and the priority sum in that other domain could be higher. Component developers must be aware of this fact and use the component meta-information to create the connections they desire.

### CASE STUDY: THE JAVA2D DEMO

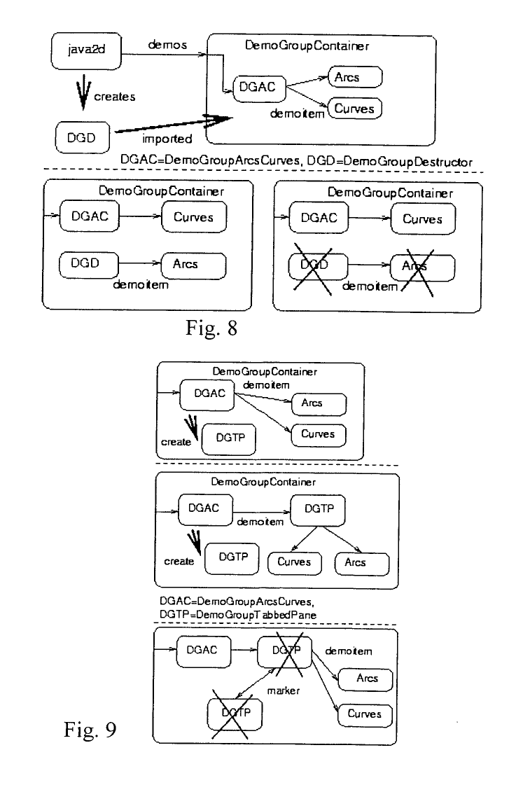

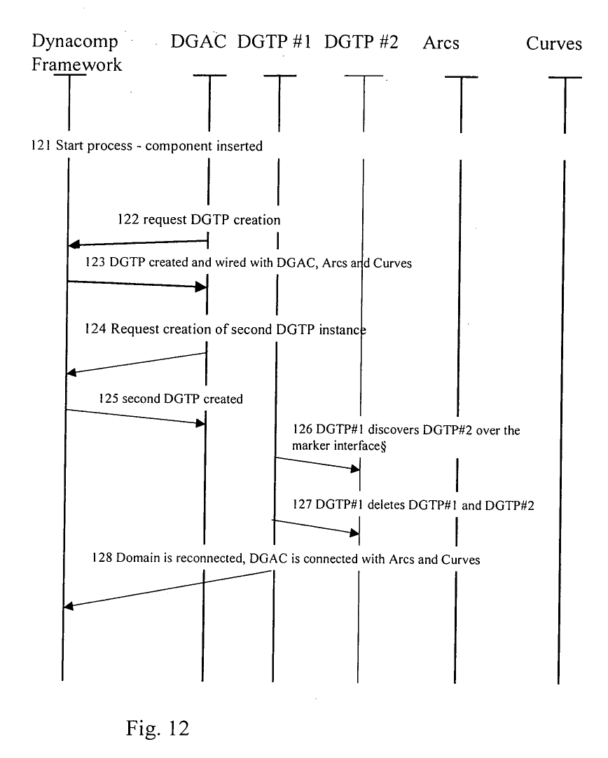

The dynamic composition will be demonstrated in the following on the familiar Java2D demo application. Java2D is a Swing application shipped with every Sun Java Development Kit as example program for demonstrating the graphical capabilities of the standard Java 2D API. Java2D demo and the underlying Java 2D API is implemented entirely in Java and the demo is highly dynamic which puts significant load onto the garbage collector. The memory needed on the heap is not only the sum of the sizes of the live objects but in order to achieve realistic performance, several times more memory is needed. Java2D can be factored into components so that user can instantiate only the services she needs. Unused services will not be instantiated therefore memory can be saved. It is shown for several cases of component instantiation and reconnection occurring in the refactored Java2D to demonstrate how dynamic composition enables this vision. The first interaction allows the user to add demos to the demo set she is able to use (FIG. 7). Demos are grouped into demo groups and one demo group is rendered on one tab. Java2D core application (main frame and intro) is represented by one instance of java2d component. First the demo group is created. One demo group is represented by one composite DemoGroupContainer. This composite component contains one demo group component instance (DemoGroupArcsCurves, DGAC) and zero or more demo component instances. First the DemoGroupContainer and DemoGroupArcsCurves are created into the same domain where java2d is. There is a super-property for the demo group and a property for the container. (demogroup=arcscurves). This means that the demo group can be placed only into a container with the same demogroup property. After the two components are created, reconnection starts. None of the components can be connected because the container's internal interfaces are not connected and the demo group super-property does not match the properties of java2d's parent therefore both are placed into the storage. The container, however can import components with demos interface so the demo group is imported into the container and the container is reconnected. This time the connection succeeds, the container's mandatory internal interfaces are connected and the container gets resolved. This, in turn, triggers reconnection at java2d's level and java2d and the container are connected over their demos interfaces. When the components are restarted, java2d checks the connection vector of its demos client interface and if a new demos connection detected, java2d queries the group's name, creates the tab and adds the drawing area created by the demo group component to the tab reserved for the demo group on Java2D application's user interface created by the demo group component to the tab. Demo components are placed into demo group similarly. The interaction when a demo component is removed from the group is interesting, however (FIG. 8). In this case java2d creates an instance of DemoltemDestructor component into its domain and sets its properties in such a way that the destructor component will be imported into the DemoGroupContainer containing the demo component and will be connected only to the demo component to be removed (demogroup and demoitem properties are used to select the container then the demo component). The priority of the destructor's demoitem interface is increased so if the destructor is propagated into the demo component's domain, it will “steal” the demo component from the demo group component. When the components are restarted, the destructor destroys both the demo component and itself triggering reconnection. The effect is that the demo component ceases to exist. Demo groups have a feature that they are able to render demos either in a grid on the same surface or individually on tabs of a tabbed pane. Referring to FIG. 12, when Java2D was componentized, this functionality was refactored by means of inserting 121 a DemoGroupTabbedPane (DGTP) component instance between the demo group and the demo components (FIG. 9). DemoGroupTabbedPane has both client and server demoitem interfaces with higher priorities than either the demo group or the demo components. The DGAC requests 122 for creation of a DBTP. Hence, after reconnection the demo group, the client interface will be connected 123 to DemoGroupTabbedPane's server interface and all the demo components will be connected to DemoGroupTabbedPane's client interface. This allows DemoGroupTabbedPane to display and hide demo components using the tabbed pane. Notice that Fractal does not allow components to have interfaces with the same name. The Dynacomp provides name mangling to create logically same names. Switching back to grid view just requires the DemoGroupTabbedPane component to be destroyed then reconnect because this will connect the demo components back their demo group. This is accomplished by creating another DemoGroupTabbedPane. DGAC requests the framework to create another DGTB 124 which is then inserted into the DemoGroupContainer 125. DemoGroupTabbedPane has an optional bidirectional marker interface. If there is one DemoGroupTabbedPane in the domain, the marker interface is unconnected. If, however, there is another DemoGroupTabbedPane, the marker interfaces are connected. When DemoGroupTabbedPane is started and discovers 126 that there is another component connected to its marker interface, it destroys 127 both that component and itself. After reconnection, DemoGroupTabbedPanes are gone and demos are connected 128 back to their demo group.

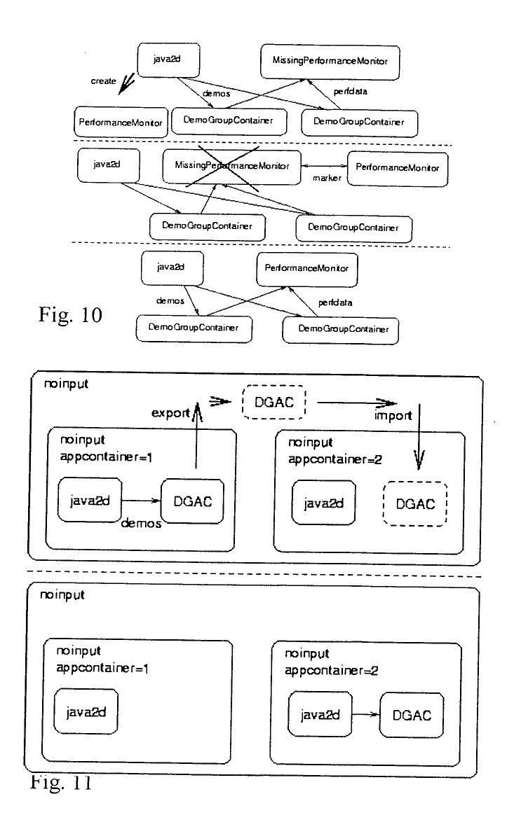

FIG. 10 illustrates a component connection rearrangement on activating a performance monitor in the demo application. Java2D has a performance monitor feature. The demonstrations measure instant performance (frames per second, for example) and send this data to the performance monitor which displays it. Enabling and disabling the performance monitor is done by replacing a dummy implementation (that has only stub code and does not display anything) with the real implementation and back. Originally the MissingPerformanceMonitor component (the dummy implementation) is instantiated and connected. When the user enables the performance monitor, an instance of PerformanceMonitor is created. The two performance monitors sense each other's presence by means of a marker interface as DemoGroupTabbedPane instances did in the previous scenario. In this case, however, the component checks the creation time of the component connected through the marker interface. The creation time is maintained by the component framework. The component destroys itself or the other component depending which one is older. The components are reconnected and the newly created performance monitor becomes operational. In order to demonstrate the power of dynamic composition in hierarchical component structures, a new feature was added to Java2D. This feature allows moving the current demo group tab to another Java2D main frame. This is realized by instantiating another java2d in a different domain (FIG. 11). That domain has a different appcontainer property. The export and import filters are set up in such a way that unconnected demo group containers are moved into this second domain and get connected with this second java2d instance. To do this, it is enough to modify the appcontainer super-property of the container component that holds all the components of a demo group (demo group and demo components) and request reconnection. By the time the component network is started, the entire demo group component set is moved into the second domain and is connected to the second java2d instance.

### IMPLEMENTATION AND RESULTS

Test runs demonstrated that it is indeed possible to save memory by loading only the features the user uses. The measurements also showed that dynamic recomposition in hierarchical arrangement is able to provide low blackout times for end-user applications.

It can be shown that the number of connections—therefore the execution time of the reconnection algorithm—can be decreased if components are arranged hierarchically instead of “flat” configuration. When using the invention, the number of connections is lower for any non-trivial grouping (so that groups consist of more than one component and there are more than one groups).

A person ordinarily skilled in the art will also appreciate that the invented component architecture is far more flexible than those known in the art. This flexibility makes the component architecture particularly, though not exclusively, suitable for implementing self-management features and especially so in case of mobile applications. The architecture is able to implement readily well-known programming paradigms in improved ways, for example the architecture provides robust event handling (events are components that are able to use other components to handle the event), aspect-oriented programming (component resolution can cause cross-cutting effects in the system) and agent-based architectures (components can act as agents).

Particular implementations and embodiments of the invention have been described. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

I claim:

1. A device including self-organising software that includes at least two components each including at least one interface for connecting with other components, wherein each of the components contains information defining component rules according to which that component can be connected with other components.

2. A device according to claim 1, wherein the components further contain information defining interface rules according to which interfaces of components can be connected with interfaces of other components.

3. A device according to claim 2, further configured to let the interface rules override the component rules.

4. A device according to claim 2, wherein the component rules and/or the interface rules contain optional rules which require certain condition to be met.

5. A device according to claim 1, wherein each component and or each interface is associated with a given priority and the device is configured to connect interfaces in dependence of these priorities

6. A device according to claim 1, each or at least some of the components being associated with a predetermined, optionally individual lifetime after which the components with a lifetime are deleted.

7. A device according to claim 1, wherein the self-organising software is organised according to a hierarchical component model.

8. A device according to claim 1, wherein the component rules are stored in the components as metainformation.

9. A device according to claim 2, wherein the interface rules are stored in the components as metainformation.

10. A device according to claim 8, wherein the meta-information includes any of the following options: mandatory properties defining a required property and its value of another component that can be connected with the component in question; conditional properties defining a property of another component that must have a given value if existent for the component to be connected with the component in question; and forbidden properties defining values which a property of another component must not have to be connected.

11. A device according to claim 9, wherein the meta-information includes any of the following options: mandatory properties defining a required property and its value of another component that can be connected with the component in question; conditional properties defining a property of another component that must have a given value if existent for the component to be connected with the component in question; and forbidden properties defining values which a property of another component must not have to be connected.

12. A device according to claim 1, wherein the components include primitive components capable of exposing their meta-information.

13. A device according to claim 1, wherein the components include one or more composite components capable containing other components by arranging connections of other components and capable of exposing meta-information dependant on the other components contained by the composite component.

14. A device according to claim 13, wherein the composite component is associated with a domain storage for containing components contained by the composite component.

15. A self-organising software for controlling a device, including at least two components each including at least one interface for connecting with other components, wherein each of the components contains information defining component rules according to which that component can be connected with other components.

16. A self-organising software according to claim 15, wherein the components further contain information defining interface rules according to which interfaces of components can be connected with interfaces of other components.

17. A self-organising software according to claim 16, further configured to let the interface rules override the component rules.

18. A self-organising software according to claim 1, wherein the component rules contain optional rules which require certain condition to be met.

19. A self-organising software according to claim 2, wherein the component rules and/or the interface rules may contain optional rules which require certain condition to be met.

20. A self-organising software according to claim 1, wherein each component and or each interface is associated with a given weight or priority and the self-organising software is configured to connect interfaces in dependence of these weights or priorities

21. A self-organising software according to claim 1, each or at least some of the components being associated with a predetermined, optionally individual lifetime after which the components with a lifetime are deleted.

22. A self-organising software according to claim 1, wherein the self-organising software is organised according to a hierarchical component model.

23. A self-organising software according to claim 15, carried or stored on a data medium or a data signal.

24. A method of self-organising software, including: identifying at least two components each including at least one interface for connecting with other components, obtaining from the components rules specific to each of the components, and determining based on the rules how each of the components can be connected with other components.

25. A method according to claim 24, wherein the components further contain information defining interface rules according to which interfaces of components can be connected with interfaces of other components.

26. A method according to claim 25, wherein the component rules and/or the interface rules may contain optional rules which require certain condition to be met.

27. A method according to claim 24, wherein the components include one or more composite components capable containing other components by arranging connections of other components and capable of exposing meta-information dependant on the other components contained by the composite component.
